(19) United States
(12) Patent Application Publication
(10) Pub. No.: US 2003/0079046 A1
(43) Pub. Date: Apr. 24, 2003

(54) Data communication method using typed continuation

(75) Inventors: Hubert Cobbaert, Lennik (BE); Luc De Ceulaer, Dilbeek (BE)

Correspondence Address: FROMMER LAWRENCE & HAUG LLP, 745 FIFTH AVENUE, NEW YORK, NY, 10151, US

(73) Assignee: SONY EUROPA B.V.

(21) Appl. No.: 10/126,796

(22) Filed: Apr. 19, 2002

Related U.S. Application Data
(63) Continuation of application No. 09/117,072, filed on Mar. 26, 1999.
Application No. 09/117,072 is a 371 of international application No. PCT/EP97/06700, filed on Nov. 26, 1997.

(30) Foreign Application Priority Data
Nov. 27, 1996 (EP) 96203335.3

(51) Int. Cl. G06F 15/163; G06F 9/54; G06F 9/00

(52) U.S. Cl. 709/310

(57) ABSTRACT

Method and apparatus for performing communication between a first program object, a second program object and/or a further program object, comprising the steps of: a) storing of intermediate results in a first memory part after execution of the first program function of the first program object; b) storing of an object identifier identifying the further program object in the first memory part; c) storing of a function identifier identifying a program function of the further program object; d) identifying the first memory part with a continuation identifier; e) identifying the first memory part with a continuation type; f) delivering a first message, the continuation identifier and the continuation type to a first program function of the second program object; g) executing said first program function of the second program object; h) delivering of the intermediate results to said program function of the further program object identified by the continuation type; i) executing said program function of the further program object.

This invention relates to a method and system for performing data communication between program objects in an object-oriented programming system, such as an object-oriented operating system (OS).

In object-oriented programming various functions of the software are formed into modules or objects. For realizing the functions of the software in its entirety, each of the program objects communicates with other objects. For this communication there is provided a mechanism between objects having properties associated with a particular application, Such as semantics, and associated interfaces (application programming interfaces or APIs). The presence of a communication mechanism between program objects having properties or interfaces is referred to as a presence of ‘environment’. In a device only one environment may be realized or plural different environments may be realized simultaneously.

A program object communicates with another program object by requesting services using message passing. After sending a message the sending program object can continue its execution or wait for a reply, In synchronous communication the program object that sent a message is suspended until it receives a reply back. In a-synchronous message passing the program object that sent a message is allowed to continue its own execution without having to wait for a response from another program object.

In the non-prepublished Japanese patent application 09-092446 of applicant a message passing communication method using continuations is disclosed. In a-synchronous message passing using continuations the operating system internally generates a subject called continuation containing intermediate results of the method of the object that is suspended. The continuation includes an object identifier, a method selector of the specified continuation method and a continuation message. The continuation is associated to a continuation identifier (ContID) which is delivered to the destination program object. A continuation can be seen as the remaining part of a set of computations, which will be performed when the continuation is activated or ‘kicked’ by the destination object. The kicking operation enables activation of the method specified by the continuation.

A continuation is uniquely associated with a continuation identifier i.e. for every continuation a different continuation identifier exists. Due to the large number of continuations in a software program, there is a chance of introducing errors by using the wrong continuation identifiers.

Also, when two or more continuations are kicked by the same program object, a corresponding number of continuation IDs have to be dealt with. This means that the programmer has to implement a large number of program codes to implement the kicking of all continuations.

The present invention however provides a method wherein the application programmer no longer accesses the continuations by their continuation identifier, but by the type of continuation only. This means that all continuations are classified into a number of different types. The continuation is associated to a type which is delivered to the destination program object. When the destination (or another object) gives the results by kicking the continuation, it uses the type to determine which continuations are to be used. Kicking a certain continuation type will result in continuation kicks of all continuations of that type.

The present invention therefore provides a method for performing communication between a first program object, a second program object and/or a further program object, comprising the steps of;

a) storing of intermediate results in a first memory part after execution of the first program function of the first program object;

b) storing of an object identifier identifying the further program object in the first memory part;

c) storing of a function identifier identifying a program function of the further program object;

d) identifying the first memory part with a continuation identifier;

e) identifying the first memory part with a continuation type;

f) delivering a first message, the continuation identifier and the continuation type to a first program function of the second program object;

g) executing said first program function of the second program object,

h) delivering of the intermediate results (a) and of the result (g) of the execution of the first program function of the second program object to said program function of the further program object identified by the continuation type;

i) executing said program function of the further program object.

The present invention allows to treat several continuation identifiers simultaneously. Preferable this is achieved by the concept of continuation bag. It is a reserved part in the memory allocated to a message where up to a fixed number of continuation identifiers and their corresponding continuation types can be stored.

In the above scenario steps a-e can be repeated up to a fixed number of times. This means that the first program object can store several intermediate results with a unique continuation identifier, with various continuation types (some of which may be equal) and various object identifiers (some of which may be equal).

The continuation bag is sent together with the first message (f) to the first program function of the second program object. The delivering of the intermediate results to said program function of a further program (h) can be triggered in the first program function of the second program object by specifying the continuation type only. If for this Continuation type several continuation identifiers are present in the continuation bag, then all these continuation identifiers will result in the delivery to all further objects of the intermediate results (a) together with the corresponding replies (g) for each individual continuation type.

The encapsulation of the continuation identifier together with the introduction of the bag concept, makes programming of message passing more secure and results in a reduced amount of code to be written.

The present invention will now be described by way of a preferred embodiment with reference to the accompanying drawings, throughout which like-parts are referred to by like-references, and in which:

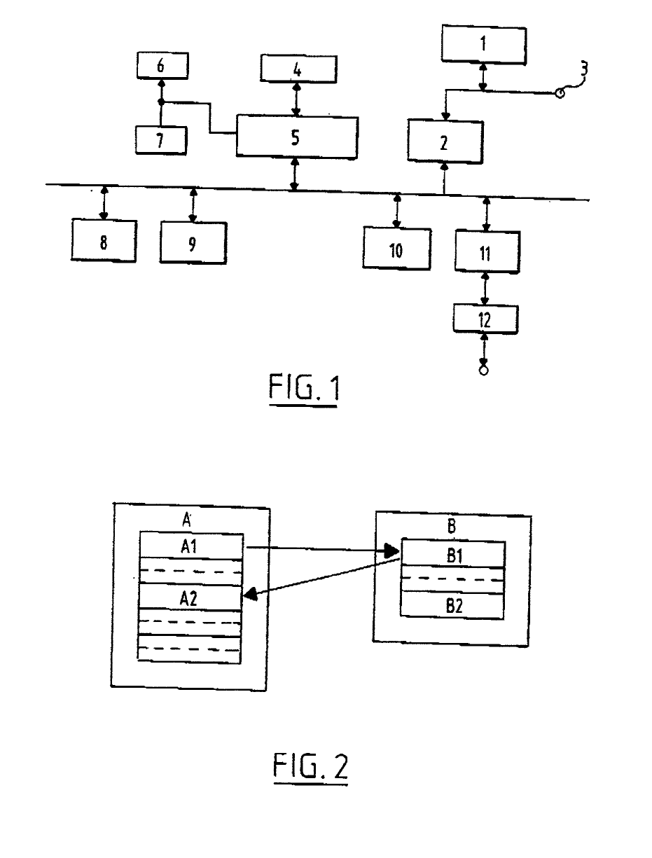

FIG. 1 is a block circuit diagram showing a schematic structure of a VCR device applying the data communication method using typed continuations;

FIG. 2 shows schematically two program objects communicating by message passing;

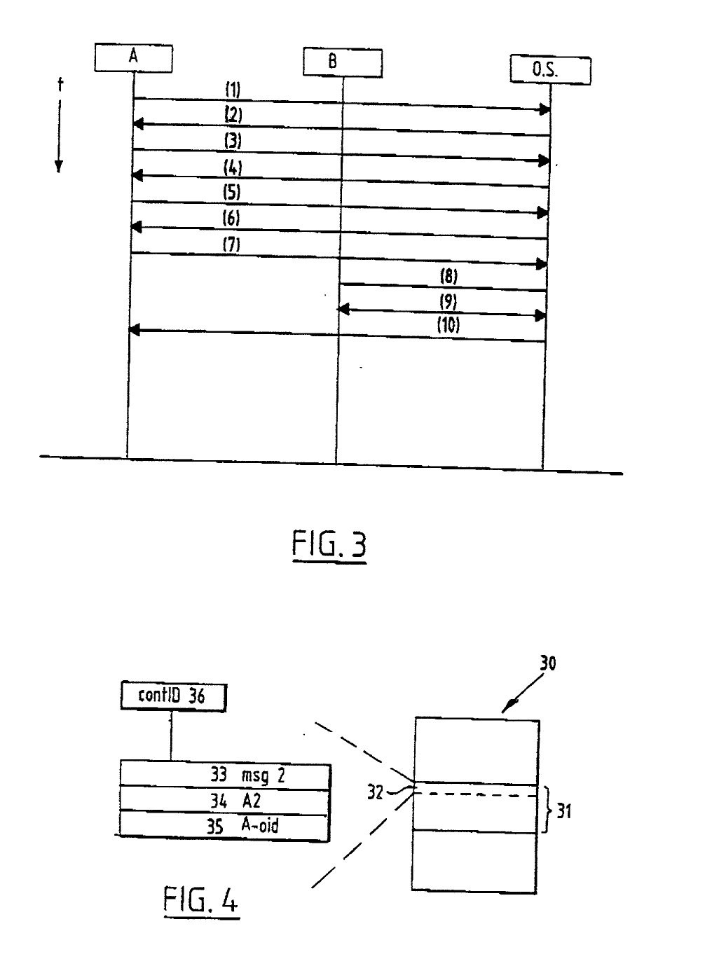

FIG. 3 shows schematically a communication mechanism using continuations;

FIG. 4 shows the memory the continuation area thereof and a specific continuation;

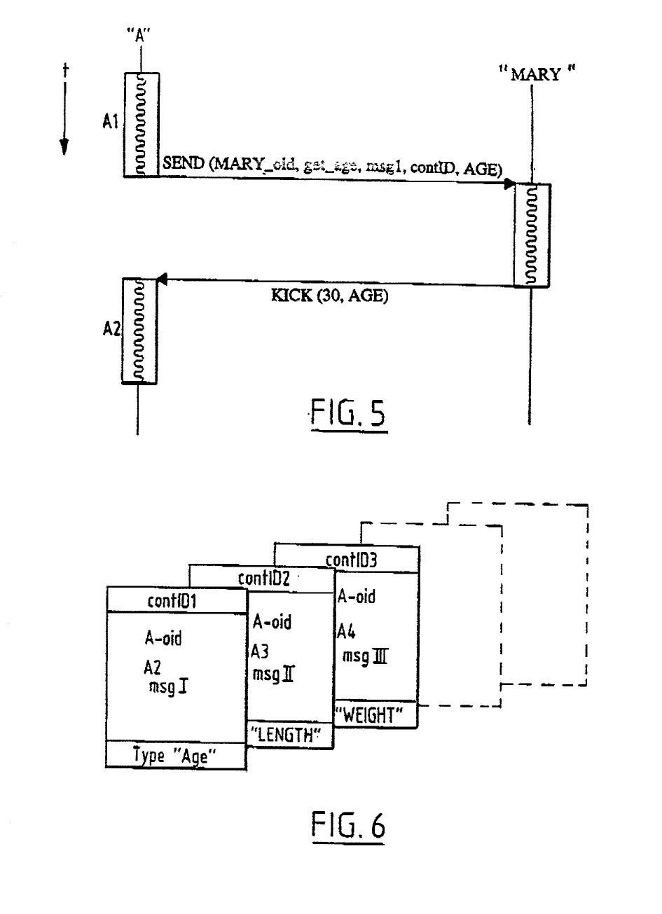

FIG. 5 shows an example using a typed continuation;

FIG. 6 shows the memory part of typed continuations.

FIG. 1 shows an example of a device structure for carrying out the data communication method for the present invention.

The device of FIG. 1 is a video cassette recorder (VCR) device for recording/reproducing signals using a video cassette comprised of a cassette and a video tape housed therein. The present invention can also be applied to other audio visual equipment (AV equipment) other than the VCR device, and also to for example office equipment or computer devices in general.

In the VCR device of FIG. 1 a VCR function unit 1 implements functions as a video cassette recorder recording/reproducing data u the video cassette. The data recorded/reproduced on the video cassette by the VCR function unit 1 is sent to other components of the device through bus/IO (Input Output) bridge 2 and can also sent out through terminal 3 to other equipment. The central processing unit (CPU) 4 is a controller for control of various parts via a bus/memory bridge S. A random access memory (RAM) 6 is of relatively small capacity and has a work area. A read only memory (ROM) 7 contains a program concerning basic functions and a program for the operating system. The CPU 4 controls various parts based on the program stored in the ROM 7 and uses the RAM 6 as a work area.

The IC-card drive 8 has a slot into which an IC-card can be inserted, as a recording medium having an integrated circuit (IC) in a card-shaped casing and an IC-card driving unit for writing/reading data on or from the IC-card. A floppy disk drive 9 includes a rotational driving unit for rotationally driving a floppy disk and a head unit for recording/reproducing data on or from the floppy disk. The floppy disk drive 9 takes charge of recording of various data and installment of application software. The hard disk drive 10 includes a rotational driving unit for rotationally driving the hard disk and a head for recording/reproducing data on or from the hard disk. A bus slot (not shown) is an extension terminal for adding an extension board, while a serial port 11 is an input/output for data communication through a modem 12.

FIG. 2 shows the basic operation of inter-object communication in a device according to FIG. 1 or equivalent device. In this figure A, B denote program object A and program object B. while A1, A2, D1 and B2 denote methods A1, A2, B1, B2 of program objects A and B. Suppose object A wishes to send a message to object B requesting it to perform some computations. After sending this message the execution of the object A is stopped until object B returns a message, Object A will only resume execution after object B has finished processing s the request of object A. The implementation of this is as follows.

FIG. 3 shows a. communication mechanism employing continuations. One of the methods of an object A, in this case method A1, intends to send a message to an object B. Therefore it creates a message msg1, using the instruction ‘new message’ which is forwarded to the operating system (1). The operating system returns a message msg1 (2). It could be that another method of object A, in this case method A2, needs some intermediate results of method A1 for execution at a later stage. Therefore A1 creates another message msg2 for these intermediate results and a continuation C, using the interfaces ‘new message’ (3) and ‘new continuation’ (5) of the operating system. The operating system returns message msg2 (4) and a continuation identifier contiD identifying the continuation (6). This continuation generally is formed by a part (32) of the continuation area (32) of the memory (30) and comprises (see FIG. 4) a method or program function selector A2 (34), an object identifier A_old (35) and a continuation message msg2 (33) which contains the intermediate results of method A1. The continuation is identified by a piece of memory (36) containing the continuation identifier contID. After creation of the two messages msg1 and msg2, the object A uses interface ‘send’ to deliver to the operating system the object identifier of the destination object B. the method selector of object B, in this case method B1, the message msg1 containing information needed to execute the object B and also an identifier (ContID) for the continuation created. The operating system in turn activates (8) or runs the appropriate method of object B, in this case method B3 of object B. If object B finishes the computations requested by object A, it activates (9) the continuation C with the continuation ID (ContID). To do this object B uses the interface ‘kick’ of the operating system, After kicking the continuation, object A continues by executing method A2. Object B is not aware which object the continuation has to be kicked to, because the continuation itself contains the method selector and the object selector of the method of the object that is to be executed, After receiving said continuation identifier contID the operating system OS activates the method of the object that was identified in the continuation (10), i.e. method A2 receives from the operating system message msg2 containing said intermediate results and is finally activated.

If results of the computations of method El are to supplier to object A, an additional message msg3 is created. When B kicks the continuation C, this message msg3 is delivered as an additional argument of the kick operation. In this case method A2 of program object A receives two messages, one is the continuation message msg2 and the other one is a result message msg3. The continuation message contains the intermediate results of Al and the result message contains the results of the computations of method BE of object B.

FIG. 5 shows an example of using type to identify continuations in a message passing mechanism. suppose that after executing program function A1 of program object A, some services from another program function are requested because, in order to be able to execute program function A2 of program object A, the age of a person called Mary is needed. This age can be determined by the program function ‘get age’ of program object Mary. Program function A1 of program object A communicates using the interface ‘send’ to deliver to the operating system Os the object identifier of the destination object, i.e Mary the method or function selector of the destination object, i.e. ‘get age’, a message msg1 containing information needed to execute the object, an identifier ContID identifying the continuation created and also a type identifying the type of continuation created. In this case the type of continuation is called ‘AGE’. The operating system activates the method ‘give age’ of object Mary. After determining the value of the age, method ‘give age’ of object Mary stops executing, and kicks the continuation with the continuation type ‘AGE’ instead of the continuation identifier ContID. Also a message msg3 containing the results of the computations of method ‘give age’ is delivered as an argument of the kick operation. In this case msg3 contains the number 30 being the requested value of the age of the person.

The advantage of the encapsulation of continuation identifiers becomes clear when it is combined with a code generator based on the IDL description of classes of program objects. In the example used the IDL description for program objects of class Mary contains following lines:

interface Mary {

void GIVE_AGE ();
. . .
exception AGE (short age);
exception WEIGHT (short weight);
exception LENGTH (short length);

}

The above IDL description expresses that the program objects of class Mary have a method GIVE_AGE( ) and can reply using three continuation types i.e. AGE, WEIGHT and LENGTH. The parameters of these replies are respectively the object's age, its weight and its length.

The IDL description for program objects of class A on the other hand

interface A {

void A1 ();
. . .
Mary::AGE A2 (long totalAgeSofar);
Mary::WEIGHT A3 (long totalWeightSofar);
Mary::LENGTH A4 (long totalLengthSofar);

}

expresses that program objects of class A have a method A1 and can accept three continuation types which are defined in the class Mary. The parameters of A2, A3 and A4 can take the intermediate results of program object A when executing method A1. In this simple example it is assumed that the intermediate results which can be stored are the total of all ages, the total of all weights, the total of all lengths of all other program objects the program object A has already contacted sofar.

The following pseudo C⁺⁺ code can be written in the method A1 of a program object of class A:

Mary_Make_GIVE_AGE_Msg( )

→CONTINUE(A_A2(ageTotal))

→SEND (Mary_old),

Here Mary_Make_GIVE_AGE_Msg is a generated constructor for a message to be delivered to the method GIVE_AGE of program object Mary. This generated code contains automatically the conversion of the method name “GIVE_AGE” to the function selector “get_age”. The CONTINUE call results in a new continuation (i.e. a new continuation identifier) which can reactivate this program object with the intermediate results (age total total age computed sofar) stored in the message created using the function A_A2( ).

The function A_A2( ) is again a generated message constructor. This function contains the information that the intermediate result ageTotal must be combined at deli-very with the continuation type AGE according to the IDL specification of program objects of class A.

The CONTINUE call also stores the continuation identifier and continuation type in the continuation bag of the message constructed with Mary_Make_GIVE_AGE_Msg( ).

Finally the last line in the pseudo code expresses that the message created by Mary_Make_GIVE_AGE_Msg ( ) must be sent to a program object identified by the object identifier Mary_old.

Program objects of class Mary can reply using the code:

Mary_ReplyAGE(30);

where Mary_ReplyAGE a generated constructor for the reply message which takes its age as an argument (here 30).

When a program object of class Mary executes the code above, the first program object of class A is triggered with the combination of parameters from the reply of Mary (in casu 30) together with the intermediate result (in casu ageTotal) The C⁺⁺ code for method A2 adding the current age to the total age then simply looks like:

void A2 (short age, long totalAgeSofar) {

ageTotal = age + totalAgeSofar;

}

The full strength of the formalism explained above becomes apparent if one decides that the method GIVE_AGE also replies the object's length. In this case it is not needed for program objects of class A to send two messages.

Indeed it is sufficient in program objects of class A to write the following pseudo code:

→Mary_Make_GIVE_AGE_Message( )

→CONTINUE(A_A2(ageTotal))

CONTINUE(A_A4(lengthTotal))

→SEND(Mary_old);

This pseudo code stores two intermediate results (ageTotal=total age computed sofar, lengthTotal=total length computed sofar). After the program object Mary executes the lines in the method GIVE AGE;

Mary_ReplyAGE (30);

Mary_ReplyLENGTH (165);

the first program object A will be triggered twice, once to get the results for the age in the method A2, and once for the results regarding the length in method A4.

It is noticed that in the pseudo code no explicit reference is made to either a function selector nor to a continuation identifier. The conversion of the method name into the function selector is generated in the message constructors. This ensures that no mix up of messages can occur e.g. delivering an invalid set of parameters to a function selector. In the same way the absence of any reference to the continuation identifier in the pseudo code ensures that no mix up of replies can happen, i.e. sending the continuation type AGE instead of the continuation type LENGTH to method A4 of program object A. Indeed in the pseudo code the CONTINUE calls ensure that the same continuation identifier is used both for the continuation storing the intermediate results as well as in the bag of the message constructed using the constructor GIVE_AGE−Message.

This clearly illustrates that encapsulation of the continuation identifier together with the introduction of the bag concept, makes programming of message passing more secure and results in a reduced amount of code to be written.

FIG. 6 shows an example of various continuations that are identified not only by their continuation ID ContID but also by their type. The continuation with continuation identifier contID1 is of type AGE, the continuation with continuation ID ContID 2 is of type LENGTH etc.

1. Method for performing communication between a first program object, a second program object and/or a further program object, comprising the steps of:
a) storing of intermediate results in a first memory part after execution of the first program function of the first program object;
b) storing of an object identifier identifying the further program object in the first memory part;
c) storing of a function identifier identifying a program function of the further program object;
d) identifying the first memory part with a continuation identifier;
e) identifying the first memory part with a continuation type;
f) delivering a first message, the continuation identifier and the continuation type to a first program function of the second program object;
g) executing said first program function of the second program object;
h) delivering of the intermediate results to said program function of the further program object identified by the continuation type;
i) executing said program function of the further program object.

2. Method according to claim 1, wherein step h also comprises the delivering of the result of the execution of the first program function of the second program object to said program function of the further program object.

3. Method according to claim 1 or 2, wherein the further program object is the first program object.

4. Method according to claim 1, 2 or 3 wherein the further program object is a third program object.

5. Method according to any of claims 1-4, wherein communication between a first program object, a second program object and/or a further program object is provided by the operating system.

6. Method according to any of claims 1-5, wherein after execution of to the second program object additionally a result message containing results of the execution of the second program object is delivered to said program function of the further program object.

7. Method according to any of claims 1-6, wherein the execution of the first program objects stops when the first program function of the first program object has been completed.

8. Apparatus implementing the method according to any of the claims 1-6.
